(19) United States
(12) Patent Application Publication
(10) Pub. No.: US 2026/0038111 A1
(43) Pub. Date: Feb. 5, 2026

(54) INDUSTRIAL PRODUCT DEFECT DETECTION METHOD AND APPARATUS, DEVICE, AND MEDIUM

(71) Applicant: TENCENT TECHNOLOGY (SHENZHEN) COMPANY LIMITED, SHENZHEN (CN)

(72) Inventors: Kai WU, SHENZHEN (CN); Yuhuan LIN, SHENZHEN (CN); Yifeng ZHOU, SHENZHEN (CN); Yong LIU, SHENZHEN (CN); Chengjie WANG, SHENZHEN (CN)

(73) Assignee: TENCENT TECHNOLOGY (SHENZHEN) COMPANY LIMITED, SHENZHEN (CN)

(21) Appl. No.: 19/352,648

(22) Filed: Oct. 8, 2025

Related U.S. Application Data
(63) Continuation of application No. PCT/CN2024/103515, filed on Jul. 4, 2024.

(30) Foreign Application Priority Data
Sep. 8, 2023 (CN) 202311155303.6

(51) Int. Cl. G06T 7/00; G06T 7/143

(52) U.S. Cl. CPC G06T 7/001; G06T 7/143; G06T 2207/20076; G06T 2207/20081; G06T 2207/20084; G06T 2207/20216; G06T 2207/20221

(57) ABSTRACT

The present disclosure discloses an industrial product defect detection method and apparatus, a device, and a medium, and belongs to the field of image processing, and may be applied to various scenarios such as a cloud technology, artificial intelligence, intelligent transportation, and assisted driving. One method includes: obtaining a first product image and a second product image; separately performing feature extraction on the first product image and the second product image to obtain a first image feature and a second image feature; merging the first image feature with the second image feature to obtain a first intermediate feature; inputting the first intermediate feature into a defect detection model to obtain an inference feature; performing up-sampling on the inference feature to obtain a second intermediate feature; and obtaining information about a position of a defect based on the second intermediate feature.

### RELATED APPLICATION

The application is a continuation application of PCT Patent Application No. PCT/CN2024/103515, filed on Jul. 4, 2024, which claims priority to Chinese Patent Application No. 202311155303.6, filed on Sep. 8, 2023, both of which are incorporated herein by reference in their entireties.

### FIELD OF THE TECHNOLOGY

The present disclosure relates to the field of image processing, and in particular, to an industrial product defect detection method and apparatus, a device, and a medium.

### BACKGROUND OF THE DISCLOSURE

In an industrial production scenario, produced industrial products often have various defects due to various reasons. For example, a color of dyed cloth is uneven, the cloth has abnormal white/black dots, the cloth has broken holes, and patterns are inconsistent. Therefore, defect detection needs to be performed on the produced industrial products.

In the related technology, the defect detection is performed by establishing a feature library. In the related technology, an image of a defect-free product is obtained, and a feature of the image of the defect-free product is stored in the feature library. Then, an image of a to-be-detected product is obtained, and if a feature of the image of the to-be-detected product is not in the feature library, it is considered that the to-be-detected product is defective.

However, the manner of using the feature library can only be applied to a single category of products. When defect detection of another category of products is performed by using the feature library, a model needs to be re-trained in the related technology.

The present disclosure describes embodiments for detecting one or more defects in one or more industrial products, addressing at least one of the problems/issues described in the present disclosure, improving generalization of the defect detection model, implementation of defect detection models on multi-category products, performance of cross-category defect detection, and/or overall production efficiency of products, and thus improving the artificial intelligence/large model fields in industrial applications.

### SUMMARY

The present disclosure provides an industrial product defect detection method and apparatus, a device, and a medium, and provides a defect detection architecture based on a large model. The defect detection architecture uses an inference capability of the large model, so that an overall architecture has a defect detection capability for cross-category products. The technical solution includes the following content.

According to an aspect of the present disclosure, an industrial product defect detection method is provided. The method includes the following operations.

An electronic device obtains a first product image and a second product image, the first product image being an image of a defect-free industrial product, and the second product image being an image of a to-be-detected industrial product.

The electronic device performs feature extraction on the first product image, to obtain a first image feature, and on the second product image, to obtain a second image feature.

The electronic device merges the first image feature with the second image feature, to obtain a first intermediate feature; and inputs the first intermediate feature into a defect detection model, to obtain an inference feature, the defect detection model being obtained through training by using various preset images of items having different appearances and modified images that are obtained by modifying the preset images.

The electronic device performs up-sampling on the inference feature, to obtain a second intermediate feature.

The electronic device obtains, based on the second intermediate feature, information about a position of a defect in the second product image.

According to another aspect of the present disclosure, an industrial product defect detection apparatus is provided. The apparatus includes the following modules: an obtaining module, a feature extraction module, a processing module, and a prediction module.

The obtaining module is configured to obtain a first product image and a second product image. In some embodiments, the first product image and the second product image are images of products having a same or similar appearance. The first product image is an image of a defect-free industrial product, and the second product image is an image of a to-be-detected industrial product.

The feature extraction module is configured to perform feature extraction on the first product image, to obtain a first image feature, and on the second product image, to obtain a second image feature.

The processing module is configured to: add the first image feature to the second image feature, to obtain a first intermediate feature; and input the first intermediate feature into a defect detection model, to obtain an inference feature. The defect detection model is obtained through training by using various images of items having different appearances and modified images that are obtained by modifying the preset images.

The processing module is further configured to perform up-sampling on the inference feature, to obtain a second intermediate feature.

The prediction module is configured to obtain, based on the second intermediate feature, information about a position of a defect in the second product image.

According to an aspect of the present disclosure, a computer device is provided, including a processor and a memory, the memory having a computer program stored therein, and the computer program being loaded and executed by the processor to implement the foregoing industrial product defect detection method.

According to another aspect of the present disclosure, a computer-readable storage medium is provided, having a computer program stored therein, the computer program being loaded and executed by a processor to implement the foregoing industrial product defect detection method.

According to another aspect of the present disclosure, a computer program product or a computer program is provided. The computer program product or the computer program includes computer instructions, and the computer instructions are stored in a computer-readable storage medium. A processor of a computer device reads the computer instructions from the computer-readable storage medium, and the processor executes the computer instructions, to make the computer device perform the foregoing industrial product defect detection method.

The technical solutions provided in embodiments of the present disclosure have at least the following beneficial effects.

A first image feature corresponding to a first product image is added to a second image feature corresponding to a second product image, to obtain a first intermediate feature; the first intermediate feature is inputted into a defect detection model, to obtain an inference feature; up-sampling operation is performed on the inference feature, to obtain a second intermediate feature; and a position of a defect is predicted based on the second intermediate feature. If the defect detection model meets at least one of the following conditions: a parameter quantity reaches a parameter quantity threshold and a network layer quantity reaches a layer quantity threshold, the defect detection model is a large model.

In other words, the present disclosure provides a defect detection architecture based on a large model. An input of the defect detection architecture is a defect-free product image and a to-be-detected product image. The defect detection architecture uses an inference capability of the large model, and the inference capability of the large model enables the overall architecture to have a defect detection capability for cross-category products. In comparison with the related technology in which defect detection can be performed only on a single category of product, the defect detection architecture provided in the present disclosure has universality.

In addition, in the related technology, a model needs to be trained again for each new product category. In an actual use process, products are quickly upgraded and replaced (for example, cloth dyeing), and a model needs to be trained again for each product of a new category, which seriously retarding a production progress. The defect detection architecture provided in the present disclosure uses the inference capability of the large model, and the inference capability of the large model enables the overall architecture to have a defect detection capability for cross-category products. The overall defect detection architecture does not need to be trained and deployed again. Regardless of how a produced product category changes, only a defect-free product image and a to-be-detected product image need to be provided. This further improves overall production efficiency of products.

In addition, the defect detection model is obtained through training based on images of a plurality of industrial product categories, helping to improve generalization of the defect detection model, further helping the defect detection model to perform cross-category defect detection.

### BRIEF DESCRIPTION OF THE DRAWINGS

To describe the technical solutions in embodiments of the present disclosure more clearly, the following briefly introduces the accompanying drawings required for describing the embodiments. Apparently, the accompanying drawings in the following description show only some embodiments of the present disclosure, and those of ordinary skill in the art may still derive other drawings from these accompanying drawings without creative efforts.

FIG. 1 is a schematic diagram of an algorithm for performing image detection and image segmentation by using a large model in the related technology.

FIG. 2 is a schematic diagram of an industrial product defect detection principle according to an embodiment of the present disclosure.

FIG. 3 is a flowchart of an industrial product defect detection method according to an embodiment of the present disclosure.

FIG. 4 is a schematic diagram of a defect detection architecture according to an exemplary embodiment of the present disclosure.

FIG. 5 is a schematic diagram of a defect detection architecture according to another exemplary embodiment of the present disclosure.

FIG. 6 is a schematic diagram of a defect detection result according to an exemplary embodiment of the present disclosure.

FIG. 7 is a flowchart of a defect detection model training method according to an exemplary embodiment of the present disclosure.

FIG. 8 is a schematic diagram of a defect detection architecture according to another exemplary embodiment of the present disclosure.

FIG. 9 is a structural block diagram of an industrial product defect detection apparatus according to an embodiment of the present disclosure.

FIG. 10 is a structural block diagram of a computer device according to an embodiment of the present disclosure.

FIG. 11 is a structural block diagram of a computer device according to another embodiment of the present disclosure.

### DESCRIPTION OF EMBODIMENTS

To make the objectives, technical solutions, and advantages of the present disclosure clearer, the following further describes the implementations of the present disclosure in detail with reference to the accompanying drawings.

First, terms described in embodiments of the present disclosure are briefly introduced.

Artificial intelligence (AI): AI is a theory, method, technology, and application system that uses a digital computer or a machine controlled by the digital computer to simulate, extend, and expand human intelligence, perceive an environment, obtain knowledge, and use the knowledge to obtain an optimal result. In other words, artificial intelligence is a comprehensive technology in computer science, and attempts to understand essence of intelligence and produce a new intelligent machine that can react in a manner similar to human intelligence. Artificial intelligence is to study design principles and implementation methods of various intelligent machines, to enable machines with functions of perception, reasoning, and decision-making.

The AI technology is a comprehensive discipline and relates to a wide range of fields including both hardware-level technologies and software-level technologies. Basic technologies of artificial intelligence generally include technologies such as sensors, dedicated artificial intelligence chips, cloud computing, distributed storage, big data processing technologies, pre-trained model technologies, operation/interaction systems, and electromechanical integration. A pre-trained model is also referred to as a large model or a basic model, which after fine adjustment, may be widely applied to downstream tasks in various large directions of artificial intelligence. Artificial intelligence software technologies mainly include several major directions, such as a computer vision technology, a speech processing technology, a natural language processing technology, and machine learning/deep learning.

Unsupervised anomaly detection: Defect detection is an important part of an industrial manufacturing process. The most important detection means is to only provide an image of a defect-free product and an image of a to-be-detected product, to make a neural network model determine whether the to-be-detected product is abnormal. The unsupervised anomaly detection means that the neural network model is not trained by using a real defect image, a training sample of the neural network model does not need to be manually marked, and only a normal image that is easily obtained needs to be used during model training.

Large model: The large model usually refers to a model with a large quantity of parameters and a deep quantity of network layers. The large model refers to a machine learning model having a large quantity of parameters and computing resources. These models require a large quantity of data and calculation capabilities in a training process, and have millions to billions of parameters. An objective of designing the large model is to improve a representation capability and performance of the model, and better capture a mode and a rule in data when a complex task is processed.

In the related art, an unsupervised anomaly detection method of an industrial product is provided. For example, PatchCore, DREAM, and SimpleNet all have a capability of inferring whether an input image is abnormal based on a normal image. PatchCore performs anomaly detection by using a feature library. In a method of PatchCore, a feature of a normal image is stored in the feature library. If an input feature of a to-be-detected image is not in the feature library, it is considered that the to-be-detected image is abnormal. The PatchCore method can only be applied to a single category of products. For example, if a wave pattern does not exist in a feature library of a first model of cloth, the wave pattern is considered as a defect of the cloth during detection. When a second model of cloth is produced, a design of the wave pattern is added to the second model of cloth. In this case, the feature library of the first model of cloth cannot be used for defect detection of the second model of cloth. DREAM uses a normal image training and reconstruction manner. If a model in DREAM has not seen an abnormal region of an inputted to-be-detected image, the model cannot reconstruct the to-be-detected image to an image of which an abnormality is repaired. SimpleNet also uses a similar reconstruction manner, and differs from DREAM in that SimpleNet considers a feature level of an image. If a model has not seen an abnormal feature of an inputted to-be-detected image, the model cannot reconstruct the abnormal feature to a normal feature.

None of the unsupervised anomaly detection methods provided in the foregoing related art can perform anomaly detection on an image that has not been seen, and is not generalized. The foregoing related art can only be applied to a single category of images.

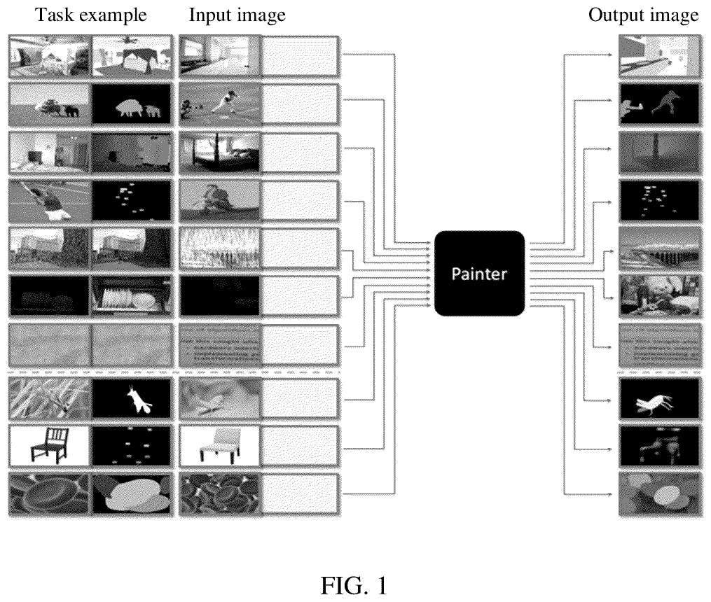

In the related art, an algorithm for performing image detection and image segmentation by using a large model is provided. For example, Painter and SegGPT can predict a new input image in a manner of imitation by using a given example (including the input image and an output image), and a model outputs a corresponding detection result and segmentation result. For example, FIG. 1 shows a model prediction manner provided by Painter in the related art. Provided task examples are shown at the leftmost side of FIG. 1, and a task example includes an input image and an output image. A new input image is shown at the middle of FIG. 1. Output results of predicting new input images by the model based on the provided task examples are shown at the right side of FIG. 1.

In the related art, performing image detection and image segmentation by using a large model relies on an imitation capability of the large model. However, unsupervised anomaly detection needs to enable a model to determine, based on a provided normal image, whether a to-be-detected image is abnormal, and requires an inferring capability. Currently, research has not been expanded to this point.

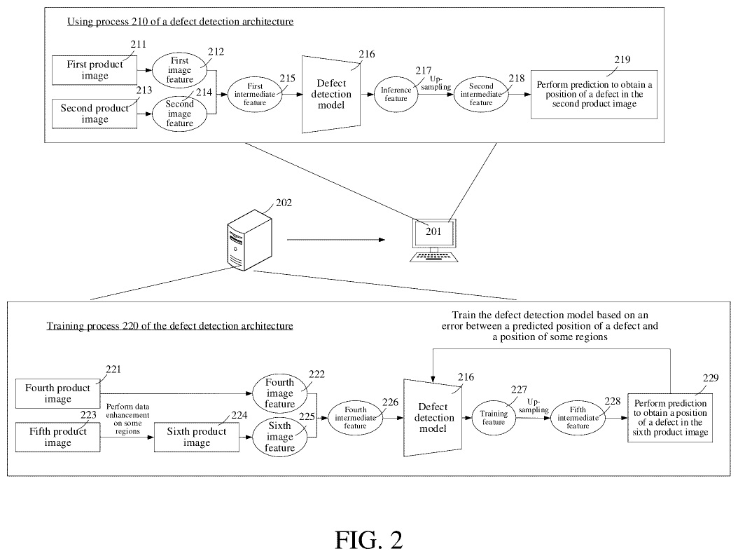

FIG. 2 is a schematic diagram of an industrial product defect detection principle according to an exemplary embodiment of the present disclosure. The computer system shown in FIG. 2 includes a using device 201 for a defect detection architecture and a training device 202 for the defect detection architecture. The training device 202 provides a defect detection architecture obtained through training to the using device 201. In some embodiments, the using device 201 and the training device 202 are a same computer device. In some embodiments, the using device 201 and the training device 202 perform transmission in a wireless or wired manner.

FIG. 2 shows a using process 210 of the defect detection architecture and a training process 220 of the defect detection architecture. In some embodiments, a position of a defect in a product image is predicted in an end-to-end manner.

FIG. 2 shows the using process 210 of the defect detection architecture. A first product image 211 is obtained, and feature output (also referred to as feature extraction) is performed on the first product image 211, to obtain a first image feature 212. A second product image 213 is obtained, and feature extraction is performed on the second product image 213, to obtain a second image feature 214. The first product image 211 and the second product image 213 are images of products under a same industrial product category. Products under a same industrial product category refer to products having a same appearance or similar appearances, for example, products of a same batch, products of a same model, or products of a same series. For example, cloth of a same model (having a same pattern or similar patterns) or printed matter of a same batch (having a same pattern or similar patterns). The first product image is an image of a defect-free product (which may also be referred to as a normal image or a standard image), and the second product image is an image of a to-be-detected product.

The first image feature 212 is merged with the second image feature 214, to obtain a first intermediate feature 215. The first intermediate feature 215 is inputted into a defect detection model 216, to output an inference feature 217. In some embodiments, if the defect detection model 216 meets at least one of the following conditions: a parameter quantity is not less than a parameter quantity threshold and a network layer quantity is not less than a layer quantity threshold, the defect detection model 216 is a large model. In some embodiments, the defect detection model 216 is a large model obtained through testing and supporting execution of a defect detection method of a general product category. The defect detection model 216 is configured to compare a to-be-detected product image with a defect-free product image, and the inference feature 217 represents a comparison result. In some embodiments, the first image feature 212 and the second image feature 214 may be added to be merged. In some embodiments, the first image feature 212 and the second image feature 214 may be averaged to be merged. In some embodiments, when the first image feature 212 and the second image feature 214 are merged, weighted consolidation, such as weighted summation and weighted average, may be performed on the two features by using a preset weight. In other embodiments, the first image feature 212 and the second image feature 214 may alternatively be added to be merged in any other feasible manner.

Up-sampling is performed on the inference feature 217, to obtain a second intermediate feature 218. The up-sampling operation is used for enlarging a size of the inference feature 217 obtained through compression by the defect detection model 216. Prediction is performed based on the second intermediate feature 218, to obtain a position 219 of a defect in the second product image.

In each embodiment, the defect detection model 216 is obtained through training by using preset images of items having different appearances of a plurality of industrial product categories and modified images that are obtained by modifying the preset images.

In some embodiments, preset regions of the preset images may be covered with image content of another image (for example, a preset specified image), to obtain the modified images. The image content of the specified image is different from image content in the preset regions of the preset images.

In some embodiments, a value of a pixel in the preset regions of the preset images may be modified to a preset value, to obtain the modified images. For example, the preset regions are cut out, or values of all pixels in the preset regions are set to preset values (for example, pixel values corresponding to a preset color).

In some embodiments, the preset regions of the preset images may be covered with a preset pattern, to obtain the modified images. For example, image content in the preset regions may be replaced with the preset pattern. For another example, the preset pattern may be superimposed on pattern content of the preset regions.

In each embodiment, a size of the preset regions is smaller than a size of the preset images.

FIG. 2 further shows the training process 220 of the defect detection architecture. A fourth product image 221 is obtained, and feature extraction is performed on the fourth product image 221, to obtain a fourth image feature 222. In addition, a fifth product image 223 is obtained, and data enhancement is performed on some regions (for example, a preset region, or a region selected from a plurality of preset regions) in the fifth product image 223 (that is, image content of the preset region is modified), to obtain an enhanced sixth product image 224. Feature extraction is performed on the sixth product image 224, to obtain a sixth image feature 225. The fourth product image 221 and the fifth product image 223 are images of defect-free products under a same industrial product category. A size of the preset region is smaller than a size of the fifth product image. In some embodiments, training data used by the defect detection architecture is from a plurality of data sets. The plurality of data sets are beneficial to improving universality of the defect detection architecture on product categories, to implement defect detection of multi-category products.

The fourth image feature 222 and the sixth image feature 225 are merged (for example, added), to obtain a fourth intermediate feature 226. The fourth intermediate feature 226 is inputted into the defect detection model 216, to output a training feature 227. Up-sampling is performed on the training feature 227, to obtain a fifth intermediate feature 228. Prediction is performed based on the fifth intermediate feature 228, to obtain a position 229 of a defect in the sixth product image. The position of the defect in the sixth product image is provided to the defect detection model, to make the defect detection model adjust a parameter in the defect detection model 216 based on an error between the predicted position 229 of the defect in the sixth product image and a position of some regions on which data enhancement is performed. In some implementations, the position of the defect in the sixth product image is provided to the defect detection model, to adjust a parameter in the defect detection model 216 based on an error between the predicted position 229 of the defect in the sixth product image and a position of some regions on which data enhancement is performed.

In the training process 220, data enhancement is performed on some regions in the fifth product image (for example, some regions in the fifth product image are covered by image content of a specified image), thereby implementing an unsupervised manner, and the entire defect detection architecture implements unsupervised anomaly detection.

Further, the defect detection model 216 is a large model, that is, the present disclosure provides a defect detection architecture for detecting a defect of an industrial product based on the large model. By using an inference capability of the large model, the defect detection architecture supports detecting defects of multi-category products. The defect detection architecture provided in the present disclosure has universality for product categories.

In the foregoing, the training device 201 of the defect detection architecture and the using device 202 of the defect detection architecture may be an electronic device having a machine learning capability, for example, a computer device. The electronic device may be a terminal or a server.

In some embodiments, the foregoing using device 201 and the training device 202 may be the same electronic device, or the using device 201 and the training device 202 may be different electronic devices. In addition, when the using device 201 and the training device 202 are different devices, the using device 201 and the training device 202 may be devices of a same category. For example, the using device 201 and the training device 202 may both be servers. Alternatively, the using device 201 and the training device 202 may be devices of different categories. The foregoing server may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The foregoing terminal may be, but is not limited to, a mobile phone, a computer, a smart voice interaction device, a smart appliance, an on-board terminal, or the like. The terminal and the server may be directly or indirectly connected in a wired or wireless communication manner. This is not limited in the present disclosure.

Information (including, but not limited to, user device information, user personal information, and the like), data (including, but not limited to, data for analysis, stored data, displayed data, and the like), and signals involved in the present disclosure are all authorized by users or fully authorized by all parties, and collection, use, and processing of related data need to comply with relevant laws, regulations, and standards of relevant countries and regions. For example, the product images involved in the present disclosure are all obtained with full authorization.

In addition, if relevant information is involved, a processor of the relevant information need to clarify an objective, a manner, and a scope of processing the relevant information by following legal, justified, and necessary principles, obtain consent of a subject of the relevant information, and take necessary technical and organizational measures to ensure security of the relevant information.

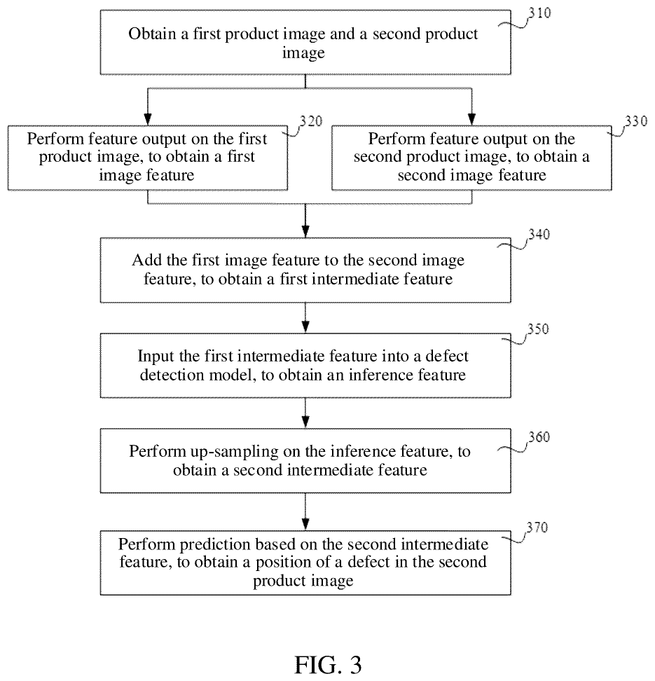

FIG. 3 is a flowchart of an industrial product defect detection method according to an exemplary embodiment of the present disclosure. Using an example in which the method is executed by the using device 201 shown in FIG. 2, the method includes the following operations.

Operation 310: Obtain a first product image and a second product image.

The first product image and the second product image are images of products having a same appearance or similar appearances (for example, products of a same industrial product category).

The industrial product category is obtained by performing classification based on a similarity degree between appearances of industrial products. In some embodiments, industrial products of a same production model are classified into a same industrial product category.

A production objective pursued by the industrial products of the same model is to produce completely same defect-free industrial products. In this case, produced industrial products of the same model are considered as under the same industrial product category. For example, a first model is standard cloth with a lotus texture, and a second model is standard cloth with a wave texture. In this case, produced cloth of the first model is under a same industrial product category, and produced cloth of the second model is under another industrial product category.

In an industrial production scenario, various defects may exist, and therefore, defect detection needs to be performed. For example, an objective of detecting a dyeing defect of cloth is to detect whether dyed cloth has inconsistency with sample cloth provided by a client, such as an uneven color, a dyed white dot or black dot, or broken hole on the cloth. As cloth textures vary, a production factory needs to produce cloth with different textures every several days.

For another example, same as detecting a dyeing defect of cloth, detecting a printing defect of cardboard needs to detect whether printed cardboard has inconsistency with sample cardboard provided by a client, such as an uneven color, a white dot or black dot, or broken hole or cracked cardboard. In addition, as printed textures vary, a production factory often needs to produce cardboard of different textures.

The first product image is an image of a defect-free industrial product. “Defect-free” herein should be considered that defects of the product are as few as negligible. In the defect detection method to be performed in the present disclosure, the first product image is used as a standard image for comparison with a to-be-detected product image.

The second product image is an image of a to-be-detected industrial product. The second product image may be an image of a defect-free industrial product, or may be an image of an industrial product with a defect. An objective of the present disclosure is to detect a position of a defect when the second product image is an image of an industrial product with a defect.

The first product image and the second product image may be obtained simultaneously or may be obtained asynchronously. This is not limited in the present disclosure.

Operation 320: Perform feature extraction on the first product image, to obtain a first image feature.

In some embodiments, the first product image may be inputted to several convolutional layers, to obtain the first image feature. The first image feature is feature representation of the first product image.

Operation 330: Perform feature extraction on the second product image, to obtain a second image feature.

In some embodiments, the second product image may be inputted to several convolutional layers, to obtain the second image feature. The second image feature is feature representation of the second product image.

Operation 340: Merge the first image feature with the second image feature, to obtain a first intermediate feature. In some implementations, operation 340 may include combining the first image feature with the second image feature, to obtain a first intermediate feature.

For example, sizes of the first image feature and the second image feature are the same. The first image feature and the second image feature are added to obtain the first intermediate feature, and the first intermediate feature is used as an input feature of a defect detection model.

Operation 350: Input the first intermediate feature into the defect detection model, to obtain an inference feature.

The defect detection model is configured to perform comparison between the first product image and the second product image. The inference feature is configured to represent a comparison result between the first product image and the second product image. The defect detection model meets at least one of the following conditions: a parameter quantity is not less than a parameter quantity threshold and a network layer quantity is not less than a layer quantity threshold. In this case, the defect detection model is a large model. In other words, the defect detection model is a backbone network (a network that plays a main role) of the large model.

In some embodiments, the defect detection model is a large model obtained through testing and supporting execution of a cross-category image detection method. In some embodiments, the defect detection model may be selected from Vit large, Vit Huge, and the like.

The defect detection model is obtained through training by using various preset images of items having different appearances and modified images that are obtained by modifying the preset images. For example, the defect detection model may be respectively obtained by training images of a plurality of industrial product categories. In other words, when the defect detection model is trained, product images of a plurality of categories (that is, images of various items having different appearances) are used for training, helping to improve generalization of the defect detection model, further helping to improve the defect detection model in performing cross-category defect detection.

In some embodiments, images of a plurality of industrial product categories used for training the defect detection model are sourced from a plurality of data sets, for example, images are from both an MVTec data set and a ViSA data set. This also helps to improve the defect detection model in performing cross-category defect detection.

Operation 360: Perform up-sampling on the inference feature, to obtain a second intermediate feature.

An up-sampling operation is used for enlarging a size of the inference feature obtained through compression by the defect detection model.

Operation 370: Obtain, based on the second intermediate feature, information about a position of a defect in the second product image.

In an embodiment, a quantity of channels of the second intermediate feature is compressed to three, to be specific, three channels: red, green, and blue, to obtain a third intermediate feature. A length and a width of the third intermediate feature are the same as a size of a pixel point matrix of the second product image. For example, the third intermediate feature is 3×h×w, and the second product image is also represented as 3×h×w.

Index normalization operation is performed on the third intermediate feature, to obtain a segmented image, and a pixel value of a pixel on the segmented image represents a probability that the pixel is a defective pixel. For example, softmax calculation is performed on the third intermediate feature, to obtain the segmented image. A pixel of which a pixel value is greater than 0.3 (or 0.5) is determined as a defective pixel based on requirements. Positions of all defective pixels constitute a position of a defect.

This is expressed by using a formula as F=softmax (Convs (x)), where x is the second intermediate feature, Convs is a convolution operation configured for compressing the quantity of channels to three, F is the segmented image, and softmax is an index normalization function.

In conclusion, the first image feature corresponding to the first product image is added to the second image feature corresponding to the second product image, to obtain the first intermediate feature; the first intermediate feature is inputted into the defect detection model, to obtain the inference feature; the up-sampling operation is performed on the inference feature, to obtain the second intermediate feature; and information about the position of the defect is obtained based on the second intermediate feature. If the defect detection model meets at least one of the following conditions: a parameter quantity reaches a parameter quantity threshold and a network layer quantity reaches a layer quantity threshold, the defect detection model is a large model.

In other words, the present disclosure provides a defect detection architecture based on a large model. An input of the defect detection architecture is a defect-free product image and a to-be-detected product image. The defect detection architecture uses an inference capability of the large model, and the inference capability of the large model enables the overall architecture to have a defect detection capability for cross-category products. In comparison with the related technology in which defect detection can be performed only on a single category of product, the defect detection architecture provided in the present disclosure has universality.

In addition, in the related technology, a model needs to be trained again for each new product category. In an actual use process, products are quickly upgraded and replaced (for example, cloth dyeing), and a model needs to be trained again for each product of a new category, which seriously retarding a production progress. The defect detection architecture provided in the present disclosure does not need to be trained and deployed again. Regardless of how a produced product category changes, only a defect-free product image and a to-be-detected product image need to be provided. This further improves overall production efficiency of products.

In addition, the defect detection model is obtained through training based on images of a plurality of industrial product categories, helping to improve generalization of the defect detection model, further helping the defect detection model to perform cross-category defect detection. In addition, the foregoing describes that the information about the position of the defect is obtained by using the segmented image. A manner of generating the segmented image is relatively simple, and the segmented image can intuitively and accurately present a defective pixel point, thereby completely presenting a product defect.

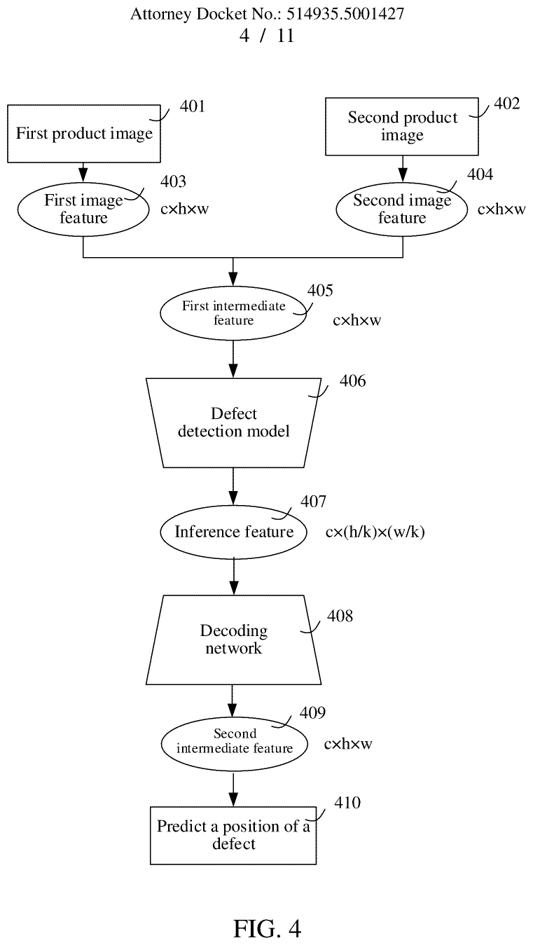

Based on the embodiment shown in FIG. 3, FIG. 4 shows a defect detection architecture according to an embodiment.

(1) Obtain a first product image 401 and a second product image 402, perform feature extraction on the first product image 401 (in some embodiments, the feature extraction is performed by some convolutional layers), to obtain a first image feature 403, and perform feature extraction on the second product image 402 (in some embodiments, the feature extraction is performed by some convolutional layers), to obtain a second image feature 404. A shape of the first image feature 403 is the same as a shape of the second image feature 404.

For example, the first image feature 403 is represented as c×h×w, and the second image feature 404 is represented as c×h×w. c is a quantity of channels of the feature, h is a width of the feature, and w is a length of the feature.

For example, a size of the first product image 401 is 3×h×w, where 3 indicates three channels of the image: red, green, and blue, h indicates a width of the image, and w is a height of the image. c is an integer greater than 3, and the first image feature 403 is used to expand the quantity of channels of the image and represent the image. For example, a size of the second product image 402 is 3×h×w, where 3 indicates three channels of the image: red, green, and blue, h indicates a width of the image, and w is a height of the image. c is an integer greater than 3, and the second image feature 404 is used to expand the quantity of channels of the image and represent the image.

(2) Add the first image feature 403 to the second image feature 404, to obtain a first intermediate feature 405. A shape of the first intermediate feature 405 is the same as shapes of the first image feature 403 and the second image feature 404.

For example, the first image feature 403 represented as c×h×w is added to the second image feature 404 represented as c×h×w, to obtain the first intermediate feature 405 represented as c×h×w.

(3) Input the first intermediate feature 405 into a defect detection model 406, to output an inference feature 407. In some embodiments, the defect detection model 406 is configured to perform feature compression on the first intermediate feature 405, to obtain the inference feature 407. A size of the inference feature 407 is smaller than a size of the second image feature 404 (or the first image feature 403). In some embodiments, the defect detection model 406 is configured to perform feature compression on a length and a width of the first intermediate feature 405 to an equal degree, to obtain the inference feature 407. The length of the inference feature 407 is less than the length of the second image feature 404 (or the first image feature 403), and the width of the inference feature 407 is less than the width of the second image feature 404 (or the first image feature 403).

For example, the defect detection model is configured to perform feature compression on the first intermediate feature 405 represented as c×h×w, to obtain the inference feature 407 represented as c×(h/k)×(w/k). k is a positive integer. For example, the first intermediate features 405 are represented as c×(h/32)×(w/32), c×(h/16)×(w/16).

(4) Input the inference feature 407 into a decoding network 408, to output a second intermediate feature 409.

The decoding network 408 is configured to perform feature recovery on the inference feature 407 through up-sampling, to obtain the second intermediate feature 409. A feature size of the second intermediate feature 409 is the same as a feature size of the first intermediate feature 405. A size of the inference feature 407 is changed to the size of the second image feature 404 (or the first image feature 403) through up-sampling, to obtain the second intermediate feature 409.

In some embodiments, the decoding network 408 is configured to perform feature recovery to an equal degree through up-sampling on the length and the width of the inference feature 407, to obtain the second intermediate feature 409. Through up-sampling, the length of the inference feature 407 is changed to the length of the second image feature 404 (or the first image feature 403), and the width of the inference feature 407 is changed to the width of the second image feature 404 (or the first image feature 403).

For example, the decoding network 408 is configured to perform feature recovery through up-sampling on the inference feature 407 represented as c×(h/k)×(w/k), to obtain the second intermediate feature 409 represented as c×h×w. In some embodiments, the decoding network 408 is a decoder in MAE (a paper named Masked Autoencoders Are Scalable Vision Learners).

(5) Perform operations of obtaining information 410 about a position of a defect based on the second intermediate feature 409.

In conclusion, the foregoing embodiment provides a feature map size at each stage of the defect detection architecture, and further provides an overall structural design of the defect detection architecture, so that defect detection can be implemented by inputting only an image of a non-defect product and an image of a to-be-detected product.

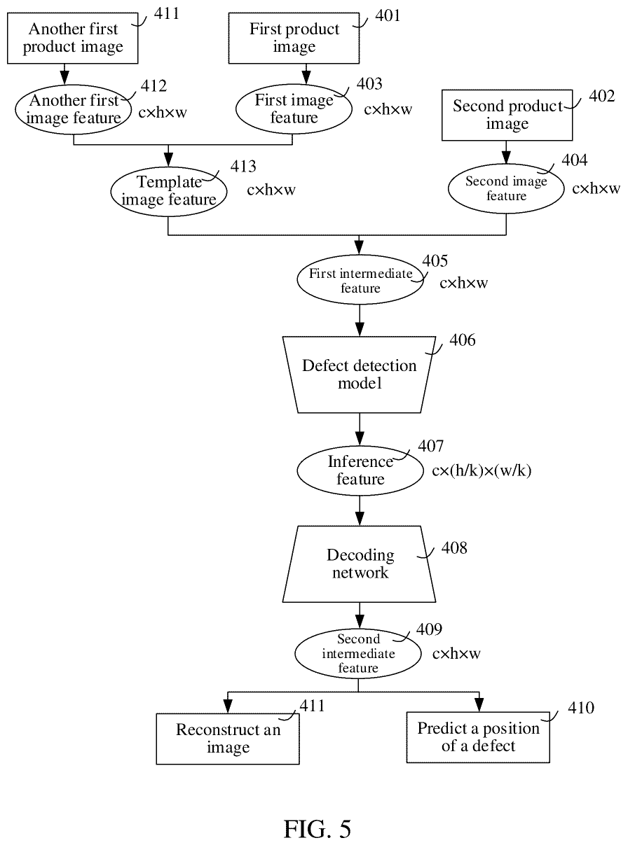

Based on the defect detection architecture shown in FIG. 4, FIG. 5 shows a further defect detection architecture.

FIG. 5 shows that during defect detection, an additional product image 411 is further obtained. The additional product image 411 is an image of another defect-free industrial product under the same industrial product category as the first product image 401. Feature extraction is performed on the additional product image 411 (in some embodiments, the feature extraction is performed by some convolutional layers), to obtain an additional image feature 412.

Combination is performed based on the additional image feature 412 and the first image feature 403, to obtain a template image feature 413. The template image feature 413 and the second image feature 404 are merged (for example, added), to obtain the first intermediate feature 405.

In some embodiments, a shape of the first image feature 403 and a shape of the additional image feature 412 are the same. An average value of the first image feature 403 and the additional image feature 412 is calculated, to obtain the template image feature 413. A shape of the template image feature 413 is the same as shapes of the first image feature 403 and the additional image feature 412.

For example, the first image feature 403 and the additional image feature 412 are both represented as c×h×w, where c is a quantity of channels of the feature, h is a width of the feature, w is a length of the feature, and c, h, and w are positive integers. An average value of the first image feature 403 represented as c×h×w and the additional image feature 412 represented as c×h×w is calculated, to obtain the template image feature 413 represented as c×h×w.

In some embodiments, the first product image 401 and the additional image 411 share a convolutional layer for feature extraction.

FIG. 5 further shows operations of reconstructing the image 411 based on the second intermediate feature 409. Image reconstruction is performed based on the second intermediate feature, to obtain a third product image, and the third product image represents an image after defect repairing in the second product image; and the third product image is provided to the defect detection model, to make the defect detection model adjust a parameter in the defect detection model by using a difference between the third product image and the first product image. In an embodiment, the quantity of channels of the second intermediate feature is compressed to three, to be specific, three channels: red, green, and blue, and then image reconstruction is performed. In some implementations, the third product image may be provided to the defect detection model to adjust a parameter in the defect detection model based on a difference between the third product image and the first product image.

This is expressed in a formula as F=Convs (x), where x is the second intermediate feature, Convs is a convolution operation used to compress the quantity of channels to three, and F is the third product image (a reconstruction result).

In conclusion, in the foregoing embodiment, a feature of a template image is obtained based on image features of a plurality of defect-free products. Different images of defect-free products may have different features. Further, features in a plurality of conditions are fused to the template image, to obtain a standard feature. For example, an image of a defect-free product is photographed in a bright light condition (for example, in a sunny day), and another image of a defect-free product is photographed in a weak light condition (for example, in a rainy day). A fused template image can have a standard lighting feature closer to that of a defect-free product, thereby improving a comparison effect between the defect-free product image and the to-be-detected product image, and making a defect detection result more accurate.

In addition, image reconstruction is further performed based on the second intermediate feature. A reconstructed image may further be configured to repair a defect in the to-be-detected product image.

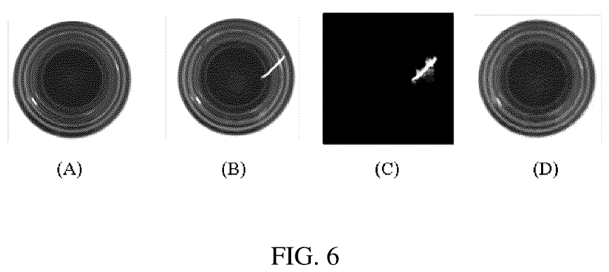

FIG. 6 shows a schematic diagram of a defect detection result according to an exemplary embodiment of the present disclosure.

A part (A) of FIG. 6 is an image of a defect-free product (namely, a first product image), a part (B) of FIG. 6 is an image of a to-be-detected product (herein, an image of a product having a defect is shown), a part (C) of FIG. 6 shows an obtained position of a defect, and the part (C) of FIG. 6 is the foregoing segmented image. A part (D) of FIG. 6 shows a reconstructed image, that is, the part (D) of FIG. 6 shows an image after defect repairing in the second product image. The defect detection architecture already obtains all defects through prediction, and the reconstructed image has no defect.

After a test, in the present disclosure, an AUROC (Area Under the Receiver Operating Characteristic Curve, area under the ROC curve) of 90 can be directly achieved by using a Vit Large (defect detection model) on an MVtec data set, which simply means that accuracy reaches 90%, and can be actually applied to a production line to satisfy a normal use requirement. A better effect may be obtained by fine adjustment of an output defect threshold. To ensure universality, a defect threshold is set to 0.5.

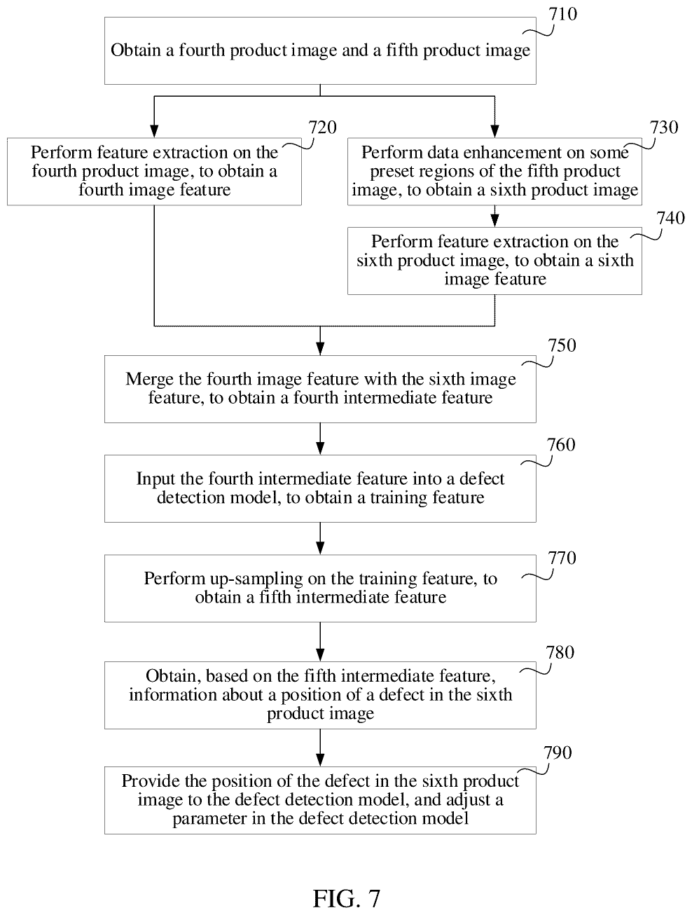

FIG. 7 shows a flowchart of a defect detection model training method according to an exemplary embodiment of the present disclosure. FIG. 7 shows training a defect detection model in an unsupervised manner. In some embodiments, a defect position is predicted end-to-end, and all neural networks in a defect detection framework are trained during training. FIG. 7 shows a training method for a defect detection model. An example in which the method is performed by the training device 202 in FIG. 2 is used for description. The method includes the following operations.

Operation 710: Obtain a fourth product image and a fifth product image.

The fourth product image and the fifth product image are images of defect-free products under a same industrial product category. For example, the fourth product image and the fifth product image are images for a camera lens or images for cloth. The fourth product image and the fifth product image are training samples. In some embodiments, the fourth product image and the fifth product image are images in the MVTec data set. Alternatively, the fourth product image and the fifth product image are images in a ViSA data set.

The MVTec data set includes 5354 high-resolution color images of different target and texture categories. They include normal images (that is, not including defects) for training and abnormal images for testing. Abnormality in the MVTec data set has 70 different categories of defects, such as scratch, dent, pollution, and different structural changes.

The ViSA data set includes 12 subsets, corresponding to 12 different objects. There are 10821 images in total, including 9621 normal samples and 1200 abnormal samples.

Operation 720: Perform feature extraction on the fourth product image, to obtain a fourth image feature.

In some embodiments, the fourth product image is inputted to several convolutional layers, to obtain the fourth image feature. The fourth image feature is feature representation of the fourth product image.

Operation 730: Perform data enhancement (that is, modification, where for a specific modification manner, refer to the foregoing descriptions) on some preset regions of the fifth product image, to obtain a sixth product image.

In some embodiments, some preset regions of the fifth product image are covered with image content of a specified image, to obtain the sixth product image. The image content of the specified image is different from image content of the some preset regions of the fifth product image.

For example, the some preset regions of the fifth product image are cut, and the image content of the specified image is copied and pasted to the some preset regions on the fifth product image, to obtain the sixth product image.

Operation 740: Perform feature extraction on the sixth product image, to obtain a sixth image feature.

In some embodiments, the sixth product image is inputted into several convolutional layers, to obtain the sixth image feature. The sixth image feature is feature representation of the sixth product image.

Operation 750: Merge (for example, add) the fourth image feature with the sixth image feature, to obtain a fourth intermediate feature.

For example, sizes of the fourth image feature and the sixth image feature are the same. The fourth image feature and the sixth image feature are added to obtain the fourth intermediate feature, and the fourth intermediate feature is used as an input feature of the defect detection model.

Operation 760: Input the fourth intermediate feature into the defect detection model, to obtain a training feature.

The fourth intermediate feature is inputted into the defect detection model, to obtain the training feature.

Operation 770: Perform up-sampling on the training feature, to obtain a fifth intermediate feature.

The up-sampling operation is configured for enlarging a size of the inference feature obtained through compression by the defect detection model.

Operation 780: Obtain, based on the fifth intermediate feature, information about a position of a defect in the sixth product image.

The information about the position of the defect in the sixth product image is obtained based on the fifth intermediate feature.

Operation 790: Provide the position of the defect in the sixth product image to the defect detection model, to make the defect detection model adjust a parameter in the defect detection model based on an error between the position of the defect and a position of the preset region. In some implementations, operation 790 may include providing the position of the defect in the sixth product image to the defect detection model to adjust a parameter in the defect detection model based on an error between the position of the defect and a position of the preset region.

In some embodiments, the defect detection model is adjusted based on an error between a pixel coordinate of the position of the defect and a pixel coordinate of partial regions. By using the error, the defect detection model can optimize a capability of predicting a defect position.

In an embodiment, the training device 201 further performs image reconstruction based on the fifth intermediate feature, to obtain a seventh product image; and trains the defect detection model based on an error between the seventh product image and the fifth product image. An error between a reconstructed image and an original image is configured for helping the defect detection model to optimize a cognitive capability of a defect-free product image. Further, the defect detection model also optimizes cognition of structure information of the defect-free product image.

A training process and a using process of the defect detection architecture are similar. For other content about the training process of the defect detection architecture, refer to the introduction of the foregoing using process.

In conclusion, the foregoing embodiment provides an unsupervised training manner of the defect detection model. Data enhancement is performed on some regions, and the defect detection model is trained based on an error between some regions and a predicted defect position, thereby satisfying a feature of unsupervised anomaly detection.

In addition, in the foregoing embodiment, the defect detection model is trained by using a reconstruction error between the reconstructed image and the original image. The reconstruction error helps the defect detection model to learn that the first product image is a defect-free product (a normal image), and helps the defect detection model to learn the structure information of the defect-free product, thereby helping to predict a position of a defect.

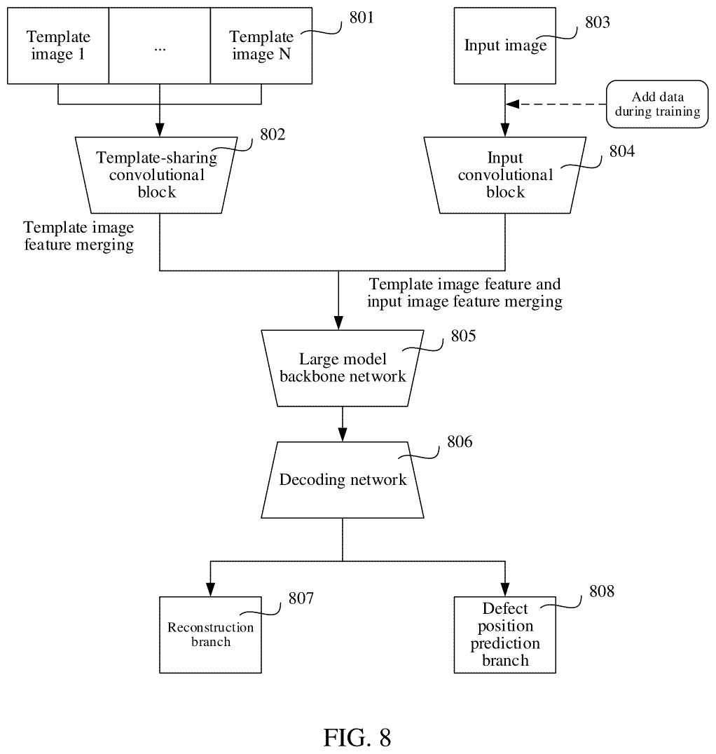

FIG. 8 shows a schematic diagram of an industrial product defect detection framework according to an exemplary embodiment of the present disclosure.

(1) Template image branch: N template images 801 (that is, images of a normal product) are given, and are inputted into a template-sharing convolutional block (that is, some convolutional layers, which are not fixed but changeable); a size of a feature outputted by each image is c×h×w (where c is a quantity of channels, h is a width of a convolved image feature, and w is a length of the convolved image feature); and template image feature merging (direct averaging of a plurality of images) is performed, to obtain a feature of c×h×w.

(2) Input image branch: An input image 803 passes through an input convolution block (that is, some convolutional layers, which are not fixed but changeable), and a feature size of an obtained input image is also c×h×w.

(3) Large model backbone network 805: A feature of the input image and a feature of the template image are directly added together, and a feature shape is still c×h×w; and then a large model backbone network 805 (the large model backbone network is a network with a large quantity of parameters, for example, Vit Large or Vit Huge) performs feature extraction.

(4) Decoding network 806: As a result outputted by the large model backbone network 805 may compress features to be small, a usually inputted size of c×h×w may relatively become c×(h/32)×(w/32), c×(h/16)×(w/16), or the like, and an up-sampling operation needs to be performed by using some convolutional layers. In some embodiments, the decoding network 806 is a decoder in MAE.

A main function of the decoding network is to restore a feature to a size of an image. A quantity of channels of the last network layer of the decoding network is increased, and then an output feature is limited to a size of the input image 803.

(5) Reconstruction branch 807: A reconstruction branch is intended to repair the input image 803 to a defect-free image. As unsupervised anomaly detection does not have a supervision signal, but the large model needs to understand a feature of an input template image to infer an abnormality, the reconstruction branch 807 reconstructs an original image by using a feature of the large model backbone network 805, to help the large model to have a cognitive capability of the input template image.

In a training process, because of unsupervised training, images are normal without defect, and are enhanced by adding some data. For example, a region of a specified image is copied and pasted to the input image 803, some black regions are directly cut out, and then the reconstruction branch 807 directly uses an enhanced image to reconstruct back to the input image 803 before enhancement.

Due to attention to universality, model training is best across data sets. In some embodiments, MvTec and ViSA are used as training data sets.

(6) Defect position prediction branch 808: This branch directly outputs a segmented image of which a size is the same as that of an original image, and each pixel has an abnormal branch, reflecting end-to-end defect detection.

As the model can directly predict a defect position end to end (a defect position prediction branch), after the template image 801 is directly inputted, an image that needs to be detected is inputted (the input image 803), and the segmented image obtained by predicted by the defect position prediction branch 808 can be directly used; and a length and a width of the segmented image are the same as those of the original image, and a probability value that each pixel value in which a single pixel being a defect is [0, 1]. Determine whether a pixel is a defective pixel by limiting a threshold. For example, based on an actual requirement, a threshold of 0.3 or 0.5 is used.

In a training process, because of unsupervised training, images are normal without defect, and are enhanced by adding some data. For example, copy and paste a region of a specified image to the input image 803, directly cut out some black regions, and then the defect position prediction branch 808 predicts a cut-out region.

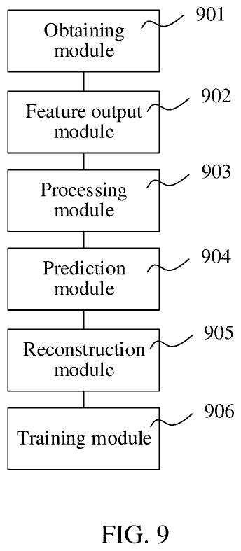

FIG. 9 shows a structural block diagram of an industrial product defect detection apparatus according to an exemplary embodiment of the present disclosure. The apparatus includes the following modules: an obtaining module 901, a feature extraction module 902, a processing module 903, and a prediction module 904.

The obtaining module 901 is configured to obtain a first product image and a second product image. The first product image and the second product image are images of products (for example, products under a same industrial product category) having a same appearance or similar appearances, the first product image is an image of a defect-free industrial product, and the second product image is an image of a to-be-inspected industrial product.

The feature extraction module 902 is configured to perform feature extraction on the first product image, to obtain a first image feature, and on the second product image, to obtain a second image feature.

The processing module 903 is configured to: add the first image feature to the second image feature, to obtain a first intermediate feature; and input the first intermediate feature into a defect detection model, to obtain an inference feature. The defect detection model is obtained through training based on various preset images of items having different appearances (for example, products of a plurality of industrial product categories) and modified images that are obtained by modifying the preset images.

The processing module 903 is further configured to perform up-sampling on the inference feature, to obtain a second intermediate feature.

The prediction module 904 is configured to obtain, based on the second intermediate feature, information about a position of a defect in the second product image.

In an embodiment, a size of the inference feature is smaller than a size of the second image feature. The processing module 903 is further configured to change, through up-sampling, the size of the inference feature to the size of the second image feature, to obtain the second intermediate feature.

In an embodiment, a length of the inference feature is smaller than a length of the second image feature, and a width of the inference feature is smaller than a width of the second image feature. The processing module 903 is configured to change, through up-sampling, the length of the inference feature to the length of the second image feature, and the width of the inference feature to the width of the second image feature, to obtain the second intermediate feature.

In an embodiment, the obtaining module 901 is further configured to obtain an additional product image. The additional product image is an image of another defect-free industrial product under the same industrial product category as the first product image. The feature extraction module 902 is further configured to: perform feature extraction on the additional product image, to obtain an additional image feature, and obtain a template image feature based on a combination of the additional image feature and the first image feature. The processing module 903 is further configured to add the template image feature to the second image feature, to obtain the first intermediate feature.

In an embodiment, a size of the first image feature and a size of the additional image feature are the same. The feature extraction module 902 is further configured to calculate an average value of the first image feature and the additional image feature, to obtain the template image feature, and a size of the template image feature is the same as the size of the first image feature and the size of the additional image feature.

In an embodiment, the prediction module 904 is further configured to compress a quantity of channels of the second intermediate feature to three, to obtain a third intermediate feature. A length and a width of the third intermediate feature are the same as a size of a pixel point matrix of the second product image.

An index normalization operation is performed on the third intermediate feature, to obtain a segmented image, and a pixel value of a pixel on the segmented image represents a probability that the pixel is a defective pixel.

In an embodiment, the apparatus further includes a reconstruction module 905. The reconstruction module 905 is configured to perform image reconstruction based on the second intermediate feature, to obtain a third product image. The third product image represents an image after defect repairing in the second product image.

In an embodiment, the obtaining module 901 is further configured to: obtain a fourth product image and a fifth product image, where the fourth product image and the fifth product image are images of defect-free products under a same industrial product category; and perform data enhancement on some regions of the fifth product image, to obtain a sixth product image.

The feature extraction module 902 is further configured to perform feature extraction on the fourth product image, to obtain a fourth image feature, and on the sixth product image, to obtain a sixth image feature.

The processing module 903 is further configured to: merge the fourth image feature with the sixth image feature, to obtain a fourth intermediate feature; input the fourth intermediate feature into the defect detection model, to obtain a training feature; and perform up-sampling on the training feature, to obtain a fifth intermediate feature.

The prediction module 904 is configured to obtain, based on the fifth intermediate feature, information about a position of a defect in the sixth product image.

The apparatus further includes a training module 906. The training module 906 is configured to train the defect detection model based on an error between a predicted position of a defect and a position of some regions.

In an embodiment, the obtaining module 901 is further configured to cover some regions of the fifth product image with image content of a specified image, to obtain the sixth product image. The image content of the specified image is different from image content of the some regions of the fifth product image.

In an embodiment, the reconstruction module 905 is further configured to provide a position of a defect in the sixth product image to the defect detection model, to make the defect detection model perform image reconstruction based on the fifth intermediate feature, to obtain a seventh product image. The training module 906 is further configured to train the defect detection model based on an error between the seventh product image and the fifth product image.

In an embodiment, images of a plurality of industrial product categories for training the defect detection model are from a plurality of data sets. For example, the obtaining module 901 may obtain the fourth product image and the fifth product image from the plurality of data sets, and the plurality of data sets include images of various items with different appearances.

In conclusion, a first image feature corresponding to a first product image is added to a second image feature corresponding to a second product image, to obtain a first intermediate feature; the first intermediate feature is inputted into a defect detection model, to obtain an inference feature; an up-sampling operation is performed on the inference feature, to obtain a second intermediate feature; and a position of a defect is predicted based on the second intermediate feature. If the defect detection model meets at least one of the following conditions: a parameter quantity reaches a parameter quantity threshold and a network layer quantity reaches a layer quantity threshold, the defect detection model is a large model.

In other words, the present disclosure provides a defect detection architecture based on a large model. An input of the defect detection architecture is a defect-free product image and a to-be-detected product image. The defect detection architecture uses an inference capability of the large model, and the inference capability of the large model enables the overall architecture to have a defect detection capability for cross-category products. In comparison with the related technology in which defect detection can be performed only on a single category of product, the defect detection architecture provided in the present disclosure has universality.

In addition, in the related technology, a model needs to be trained again for each new product category. In an actual use process, products are quickly upgraded and replaced (for example, cloth dyeing), and a model needs to be trained again for each product of a new category, which seriously retarding a production progress. The defect detection architecture provided in the present disclosure does not need to be trained and deployed again. Regardless of how a produced product category changes, only a defect-free product image and a to-be-detected product image need to be provided. This further improves overall production efficiency of products.

In addition, the defect detection model is obtained through training based on images of a plurality of industrial product categories, helping to improve generalization of the defect detection model, further helping the defect detection model to perform cross-category defect detection.

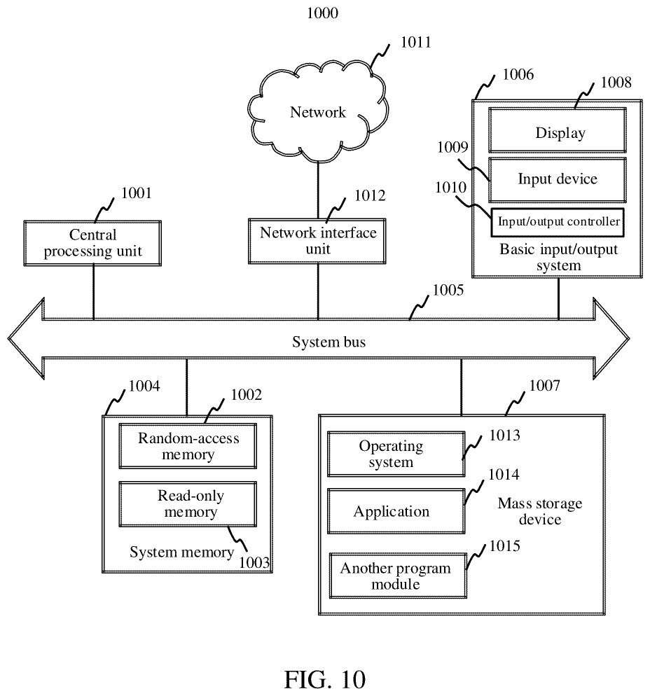

FIG. 10 is a schematic structural diagram of a computer device according to an exemplary embodiment. The computer device server 1000 includes a central processing unit (CPU) 1001, a system memory 1004 including a random access memory (RAM) 1002 and a read-only memory (ROM) 1003, and a system bus 1005 connecting the system memory 1004 and the CPU 1001. The computer device 1000 further includes a basic input/output (I/O) system 1006 assisting in information transmission between devices in the computer device, and a mass storage device 1007 configured to store an operating system 1013, an application 1014, and another program module 1015.

The basic input/output system 1006 includes a display 1008 configured to display information and an input device 1009 such as a mouse or a keyboard that is configured to input information by a user. The display 1008 and the input device 1009 are both connected to the central processing unit 1001 by using an input and output controller 1010 that is connected to the system bus 1005. The basic input/output system 1006 may further include the input and output controller 1010, to receive and process an input from a plurality of other devices such as a keyboard, a mouse, or an electronic stylus. Similarly, the input and output controller 1010 further provides an output to a display screen, a printer, or another category of output device.

The mass storage device 1007 is connected to the central processing unit 1001 by using a mass storage controller (not shown) connected to the system bus 1005. The mass storage device 1007 and an associated computer device-readable medium provide non-volatile storage for the computer device 1000. In other words, the mass storage device 1007 may include a computer device-readable medium (not shown) such as a hard disk or a compact disc read-only memory (CD-ROM) drive.

Generally, the computer device-readable medium may include a computer device storage medium and a communication medium. The computer device storage medium includes volatile and non-volatile, removable and non-removable media implemented by using any method or technology used to store information such as a computer device readable instruction, a data structure, a program module, or other data. The computer device storage medium includes a RAM, a ROM, an erasable programmable read-only memory (EPROM), an electrically erasable programmable read-only memory (EEPROM), a CD-ROM, a digital video disc (DVD) or another optical memory, a tape cartridge, a magnetic tape, a magnetic disk memory, or another magnetic storage device. Certainly, a person skilled in art can learn that the computer device storage medium is not limited to the foregoing several types. The system memory 1004 and the mass storage device 1007 may be collectively referred to as a memory.

According to various embodiments of the present disclosure, the computer device 1000 may further be connected, through a network such as the Internet, to a remote computer device on the network and run. In other words, the computer device 1000 may be connected to a network 1011 through a network interface unit 1012 connected to the system bus 1005, or may be connected to another type of network or a remote computer device system (not shown) through the network interface unit 1012.

The memory further includes one or more programs. The one or more programs are stored in the memory. The CPU 1001 executes the foregoing one or more programs to implement all or partial operations of the foregoing industrial product defect detection method.

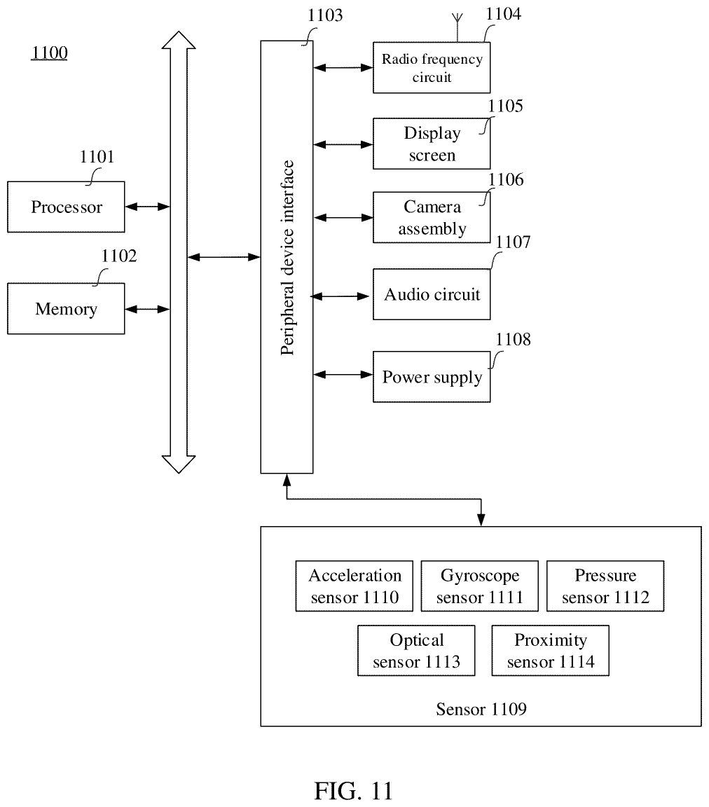

FIG. 11 shows a structural block diagram of a computer device 1100 according to an exemplary embodiment of the present disclosure. The computer device 1100 may be a portable mobile terminal, for example, a smartphone, a tablet computer, a moving picture experts group audio layer III (MP3) player, a moving picture experts group audio layer IV (MP4) player, a notebook computer, or a desktop computer. The computer device 1100 may also be referred to as another name such as user device, a portable terminal, a laptop terminal, or a desktop terminal.

Generally, the computer device 1100 includes a processor 1101 and a memory 1102.

The processor 1101 may include one or more processing cores, for example, a 4-core processor or an 8-core processor. The processor 1101 may be implemented in at least one hardware form of a digital signal processor (DSP), a field-programmable gate array (FPGA), and a programmable logic array (PLA). The processor 1101 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 1101 may be integrated with a graphics processing unit (GPU). The GPU is configured to render and draw content that needs to be displayed on a display screen. In some embodiments, the processor 1101 may further include an artificial intelligence (AI) processor. The AI processor is configured to process computing operations related to machine learning.

The memory 1102 may include one or more computer-readable storage media. The computer-readable storage medium may be non-transient. The memory 1102 may further include a high-speed random access memory and a non-volatile memory, for example, one or more disk storage devices or flash storage devices. In some embodiments, the non-transient computer-readable storage medium in the memory 1102 is configured to store at least one instruction. The at least one instruction is configured for being executed by the processor 1101 to implement the industrial product defect detection method provided in method embodiments of the present disclosure.

In some embodiments, the computer device 1100 may further include a peripheral device interface 1103 and at least one peripheral device. The processor 1101, the memory 1102, and the peripheral device interface 1103 may be connected through a bus or a signal cable. Each peripheral device may be connected to the peripheral device interface 1103 through a bus, a signal cable, or a circuit board. Exemplarily, the peripheral device may include at least one of a radio frequency circuit 1104, a display screen 1105, a camera assembly 1106, an audio circuit 1107, a power supply 1108, and one or more sensors 1109. The one or more sensors 1109 include, but are not limited to: an acceleration sensor 1110, a gyroscope sensor 1111, a pressure sensor 1112, an optical sensor 1113, and a proximity sensor 1114.

A person skilled in the art may understand that the structure shown in FIG. 11 does not constitute any limitation on the computer device 1100, and the device may include more components or fewer components than those shown in the figure, or some components may be combined, or a different component deployment may be used.

The present disclosure further provides a computer-readable storage medium, the storage medium having at least one instruction, at least one section of program, and a code set or an instruction set stored therein. The at least one instruction, the at least one section of program, and the code set or the instruction set are loaded and executed by the processor to implement the industrial product defect detection method provided by the foregoing method embodiment.

The present disclosure provides a computer program product or a computer program. The computer program product or the computer program includes computer instructions, and the computer instructions are stored in a computer-readable storage medium. A processor of a computer device reads the computer instruction from the computer-readable storage medium, and the processor executes the computer instruction, to make the computer device perform the foregoing industrial product defect detection method provided by the foregoing method embodiment.

The sequence numbers of the foregoing embodiments of the present disclosure are merely for description purpose, but do not indicate the preference of the embodiments.

A person of ordinary skill in the art may understand that all or partial operations of the foregoing embodiments may be implemented by hardware or a program instructing relevant hardware. The program may be stored in a computer-readable storage medium. The storage medium may be a read-only memory, a magnetic disk, an optical disc, or the like.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

In various embodiments in the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms.

In some other embodiments, a computer-readable medium comprising instructions which, when executed by a computer, cause the computer to carry out a portion or all of the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

The technical features in the foregoing embodiments may be randomly combined. For concise description, not all possible combinations of the technical features in the foregoing embodiments are described. However, the combinations of the technical features shall all be considered as falling within the scope described in this specification provided that they do not conflict with each other.

What is claimed is:

1. A method for detecting an industrial product defect, the method comprising:
obtaining, by an electronic device comprising a memory storing instructions and a processor in communication with the memory, a first product image and a second product image, the first product image being an image of a defect-free industrial product, and the second product image being an image of a to-be-detected industrial product;
performing, by the electronic device, feature extraction on the first product image to obtain a first image feature, and on the second product image to obtain a second image feature;
merging, by the electronic device, the first image feature with the second image feature, to obtain a first intermediate feature; and inputting the first intermediate feature into a defect detection model, to obtain an inference feature, the defect detection model being obtained through training by using various preset images of items having different appearances and modified images that are obtained by modifying the preset images;
performing, by the electronic device, up-sampling on the inference feature to obtain a second intermediate feature; and
obtaining, by the electronic device, based on the second intermediate feature, information about a position of a defect in the second product image.

2. The method according to claim 1, wherein:
a size of the inference feature is smaller than a size of the second image feature; and
the performing up-sampling on the inference feature to obtain the second intermediate feature comprises:
changing, through the foregoing up-sampling, the size of the inference feature to the size of the second image feature to obtain the second intermediate feature.

3. The method according to claim 2, wherein:
a length of the inference feature is smaller than a length of the second image feature, and a width of the inference feature is smaller than a width of the second image feature; and
the changing, through the foregoing up-sampling, the size of the inference feature to the size of the second image feature to obtain the second intermediate feature comprises:
changing, through the foregoing up-sampling, the length of the inference feature to the length of the second image feature, and the width of the inference feature to the width of the second image feature to obtain the second intermediate feature.

4. The method according claim 1, further comprising:
obtaining an additional product image, the additional product image and the first product image being images of defect-free industrial products having a same appearance or similar appearances;
performing feature extraction on the additional product image, to obtain an additional image feature; and
combining the additional image feature with the first image feature to obtain a template image feature,
wherein the merging the first image feature with the second image feature to obtain the first intermediate feature comprises:
merging the template image feature with the second image feature to obtain the first intermediate feature.

5. The method according to claim 4, wherein:
a size of the first image feature and a size of the additional image feature are the same; and
the combining the additional image feature with the first image feature to obtain the template image feature comprises:
calculating an average value of the first image feature and the additional image feature to obtain the template image feature, a size of the template image feature being the same as the size of the first image feature and the size of the additional image feature.

6. The method according to claim 1, wherein the obtaining, based on the second intermediate feature, information about the position of the defect in the second product image comprises:
compressing a quantity of channels of the second intermediate feature to three, to obtain a third intermediate feature, a size of a pixel point matrix of the third intermediate feature being the same as a size of a pixel point matrix of the second product image; and
performing index normalization operation on the third intermediate feature, to obtain a segmented image, a pixel value of a pixel on the segmented image representing a probability that the pixel is a defective pixel.

7. The method according to claim 1, further comprising:
performing image reconstruction based on the second intermediate feature, to obtain a third product image, the third product image representing an image after defect repairing in the second product image; and
providing the third product image to the defect detection model to adjust a parameter in the defect detection model based on a difference between the third product image and the first product image.

8. The method according to claim 1, further comprising:
obtaining a fourth product image and a fifth product image, the fourth product image and the fifth product image being images of a defect-free product;
modifying image content of a preset region of the fifth product image to obtain a sixth product image, a size of the preset region being smaller than a size of the fifth product image;
performing, using a feature extraction model, feature extraction on the fourth product image to obtain a fourth image feature; and performing feature extraction on the sixth product image to obtain a sixth image feature;
merging the fourth image feature with the sixth image feature to obtain a fourth intermediate feature; and inputting the fourth intermediate feature into the defect detection model to obtain a training feature;
performing up-sampling on the training feature to obtain a fifth intermediate feature;
obtaining, based on the fifth intermediate feature, information about a position of a defect in the sixth product image; and
providing the position of the defect in the sixth product image to the defect detection model, to make the defect detection model adjust a parameter in the defect detection model based on an error between the position of the defect and a position of the preset region.

9. The method according to claim 1, wherein the modified images are obtained by at least one of the following:
covering a preset region of the preset image with image content of a specified image, the image content of the specified image being different from image content of the preset region of the preset image;
modifying a value of a pixel in the preset region of the preset image to a preset value; or
covering the preset region of the preset image with a preset pattern,
wherein a size of the preset region is smaller than a size of the preset image.

10. The method according to claim 8, further comprising:
performing image reconstruction based on the fifth intermediate feature to obtain a seventh product image; and
providing the seventh product image to the defect detection model to adjust a parameter in the defect detection model based on an error between the seventh product image and the fifth product image.

11. The method according to claim 1, wherein:
the preset images are selected from a plurality of data sets, the plurality of data sets comprising images of various items with different appearances.

12. An apparatus for detecting an industrial product defect, the apparatus comprising:
a memory storing instructions; and
a processor in communication with the memory, wherein, when the processor executes the instructions, the processor is configured to cause the apparatus to perform:
obtaining a first product image and a second product image, the first product image being an image of a defect-free industrial product, and the second product image being an image of a to-be-detected industrial product,
performing feature extraction on the first product image to obtain a first image feature, and on the second product image to obtain a second image feature,
merging the first image feature with the second image feature, to obtain a first intermediate feature; and inputting the first intermediate feature into a defect detection model, to obtain an inference feature, the defect detection model being obtained through training by using various preset images of items having different appearances and modified images that are obtained by modifying the preset images,
performing up-sampling on the inference feature to obtain a second intermediate feature, and
obtaining, based on the second intermediate feature, information about a position of a defect in the second product image.

13. The apparatus according to claim 12, wherein:
a size of the inference feature is smaller than a size of the second image feature; and
when the processor is configured to cause the apparatus to perform up-sampling on the inference feature to obtain the second intermediate feature, the processor is configured to cause the apparatus to perform:
changing, through the foregoing up-sampling, the size of the inference feature to the size of the second image feature to obtain the second intermediate feature.

14. The apparatus according to claim 13, wherein:
a length of the inference feature is smaller than a length of the second image feature, and a width of the inference feature is smaller than a width of the second image feature; and
when the processor is configured to cause the apparatus to perform changing, through the foregoing up-sampling, the size of the inference feature to the size of the second image feature to obtain the second intermediate feature, the processor is configured to cause the apparatus to perform:
changing, through the foregoing up-sampling, the length of the inference feature to the length of the second image feature, and the width of the inference feature to the width of the second image feature to obtain the second intermediate feature.

15. The apparatus according to claim 12, wherein, when the processor executes the instructions, the processor is further configured to cause the apparatus to perform:
obtaining an additional product image, the additional product image and the first product image being images of defect-free industrial products having a same appearance or similar appearances;
performing feature extraction on the additional product image, to obtain an additional image feature; and
combining the additional image feature with the first image feature to obtain a template image feature,
wherein the merging the first image feature with the second image feature to obtain the first intermediate feature comprises:
merging the template image feature with the second image feature to obtain the first intermediate feature.

16. The apparatus according to claim 15, wherein:
a size of the first image feature and a size of the additional image feature are the same; and
when the processor is configured to cause the apparatus to perform combining the additional image feature with the first image feature to obtain the template image feature, the processor is configured to cause the apparatus to perform:
calculating an average value of the first image feature and the additional image feature to obtain the template image feature, a size of the template image feature being the same as the size of the first image feature and the size of the additional image feature.

17. The apparatus according to claim 12, wherein, when the processor is configured to cause the apparatus to perform obtaining, based on the second intermediate feature, information about the position of the defect in the second product image, the processor is configured to cause the apparatus to perform:
compressing a quantity of channels of the second intermediate feature to three, to obtain a third intermediate feature, a size of a pixel point matrix of the third intermediate feature being the same as a size of a pixel point matrix of the second product image; and
performing index normalization operation on the third intermediate feature, to obtain a segmented image, a pixel value of a pixel on the segmented image representing a probability that the pixel is a defective pixel.

18. The apparatus according to claim 12, wherein, when the processor executes the instructions, the processor is further configured to cause the apparatus to perform:
performing image reconstruction based on the second intermediate feature, to obtain a third product image, the third product image representing an image after defect repairing in the second product image; and
providing the third product image to the defect detection model to adjust a parameter in the defect detection model based on a difference between the third product image and the first product image.

19. The apparatus according to claim 12, wherein, when the processor executes the instructions, the processor is further configured to cause the apparatus to perform:
obtaining a fourth product image and a fifth product image, the fourth product image and the fifth product image being images of a defect-free product;
modifying image content of a preset region of the fifth product image to obtain a sixth product image, a size of the preset region being smaller than a size of the fifth product image;
performing, using a feature extraction model, feature extraction on the fourth product image to obtain a fourth image feature; and performing feature extraction on the sixth product image to obtain a sixth image feature;
merging the fourth image feature with the sixth image feature to obtain a fourth intermediate feature; and inputting the fourth intermediate feature into the defect detection model to obtain a training feature;
performing up-sampling on the training feature to obtain a fifth intermediate feature;
obtaining, based on the fifth intermediate feature, information about a position of a defect in the sixth product image; and
providing the position of the defect in the sixth product image to the defect detection model, to make the defect detection model adjust a parameter in the defect detection model based on an error between the position of the defect and a position of the preset region.

20. A non-transitory computer-readable storage medium, storing computer-readable instructions, wherein, the computer-readable instructions, when executed by a processor, are configured to cause the processor to perform:
obtaining a first product image and a second product image, the first product image being an image of a defect-free industrial product, and the second product image being an image of a to-be-detected industrial product;
performing feature extraction on the first product image to obtain a first image feature, and on the second product image to obtain a second image feature;
merging the first image feature with the second image feature, to obtain a first intermediate feature; and inputting the first intermediate feature into a defect detection model, to obtain an inference feature, the defect detection model being obtained through training by using various preset images of items having different appearances and modified images that are obtained by modifying the preset images;
performing up-sampling on the inference feature to obtain a second intermediate feature; and
obtaining, based on the second intermediate feature, information about a position of a defect in the second product image.
